(19) United States
(12) Patent Application Publication
(10) Pub. No.: US 2015/0061959 A1
(43) Pub. Date: Mar. 5, 2015

(54) ANTENNA DEVICE

(71) Applicant: Hitachi Metals, Ltd., Tokyo (JP)

(72) Inventors: Naoki ISO, Hitachi (JP); Nobuaki Kitano, Hitachi (JP); Tomoyuki Ogawa, Hitachi (JP); Yoshiaki Ishigami, Hitachi (JP)

(73) Assignee: Hitachi Metals, Ltd., Tokyo (JP)

(21) Appl. No.: 14/243,795

(22) Filed: Apr. 2, 2014

(30) Foreign Application Priority Data
Aug. 30, 2013 (JP) 2013-179481

(51) Int. Cl. H01Q 1/50; H01Q 1/48

(52) U.S. Cl. CPC H01Q 1/50; H01Q 1/48
USPC 343/848

(57) ABSTRACT

An antenna device has a feed line including a triplate line. Each triplate line has a central conductor and two ground plates sandwiching the central conductor via an air layer. At least a part of the triplate line is configured such that the two ground plates sandwich a center substrate including a wiring pattern as the central conductor provided on a dielectric substrate via the air layer.

The present application is based on Japanese patent application No. 2013-179481 filed on Aug. 30, 2013, the entire contents of which are incorporated herein by reference.

### BACKGROUND OF THE INVENTION

1. Field of the Invention

This invention relates to an antenna device.

2. Description of the Related Art

As an antenna device for suppressing a loss in a feed line and simplifying an antenna structure, e.g., an antenna device using a triplate line has been developed. The triplate line includes a central conductor plate and one pair of ground plates sandwiching the central conductor plate as a feed line.

Refer to e.g JP-A 63-88902.

### SUMMARY OF THE INVENTION

However, in the conventional antenna device using the triplate line as the feed line, there is a disadvantage in that, e.g., for the case of a frequency sharing antenna device, the central conductor plate cannot be made in one piece but should be divided into plural blocks, so that the number of parts or components will be increased and assembling work of the antenna device will become troublesome.

Accordingly, it is an object of the present invention to provide an antenna device which can be easily assembled.

According to a feature of the invention, an antenna device, comprises:
a feed line comprising a triplate line, each triplate line comprising a central conductor and two ground plates sandwiching the central conductor via an air layer;
wherein at least a part of the triplate line is configured such that the two ground plates sandwich a center substrate comprising a wiring pattern as the central conductor provided on a dielectric substrate via the air layer.

In the above embodiment of the invention, the following modifications and changes can be made.

(i) The dielectric substrate is located at a position where a first distance from one surface provided with the central conductor to one of the two ground plates facing to the one surface is greater than a second distance from the other surface opposed to the one surface to the other of the two ground plates facing to the other surface.

(ii) The dielectric substrate is located equidistantly from both of the two ground plates.

(iii) The triplate line comprises a first triplate line and a second triplate line connected to be intersected with the first triplate line,
wherein a feed signal fed from outside is transmitted from the second triplate line to an antenna element via the first triplate line,
wherein at least a part of the first triplate lines is configured such that the two ground plates sandwich the center substrate via the air layer.

(iv) The second triplate line is installed on a side of one of the two ground plates of the first triplate line and the antenna element is installed on a side of the other of the two ground plates of the first triplate line,
wherein the center substrate comprises the central conductor on the dielectric substrate on a side of the antenna element.

(vi) The center substrate is supported by the two ground plates via a spacer provided at a region of the center substrate, and the region is not provided with the spacer.

### Points of the Invention

According to the present invention, it is possible to provide an antenna device which can be easily assembled.

### BRIEF DESCRIPTION OF THE DRAWINGS

The preferred embodiments according to the invention will be explained below referring to the drawings, wherein:

FIGS. 1A and 1B show a configuration example of an antenna device in the present embodiment, wherein FIG. 1A is a schematically cross-sectional view showing the interconnection of triplate lines in the antenna device in the present embodiment, and FIG. 1B is a schematically cross-sectional view showing a structure of a first triplate line;

FIG. 2A is a perspective view showing an appearance of the antenna device in FIGS. 1A and 1B;

FIG. 2B is a perspective view showing an internal configuration of a radome, in which the plurality of triplate lines and the antenna elements are partially not shown;

FIGS. 3A and 3B show a configuration example of a second triplate line in the antenna device in FIGS. 1A and 1B, wherein FIG. 3A is a perspective view thereof in which one of ground plates is not shown, and FIG. 3B is a schematically cross-sectional view of the second triplate line;

FIG. 4 is a perspective view showing a configuration of an antenna element in the antenna device in FIG. 1, and

FIG. 5 is a perspective view of the first triplate line in the antenna device in FIG. 1 in which one of ground plates is not shown.

### DETAILED DESCRIPTION OF THE EMBODIMENTS

Next, an antenna device according to the present invention will be explained below with reference to appended drawings.

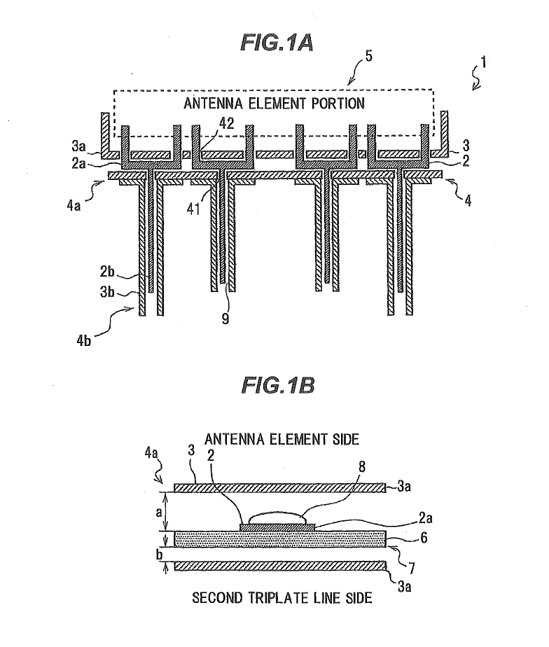

FIGS. 1A and 1B show a configuration example of an antenna device in the present embodiment, wherein FIG. 1A is a schematically cross-sectional view showing the interconnection of triplate lines in the antenna device in the present embodiment, and FIG. 1B is a schematically cross-sectional view showing a structure of a first triplate line.

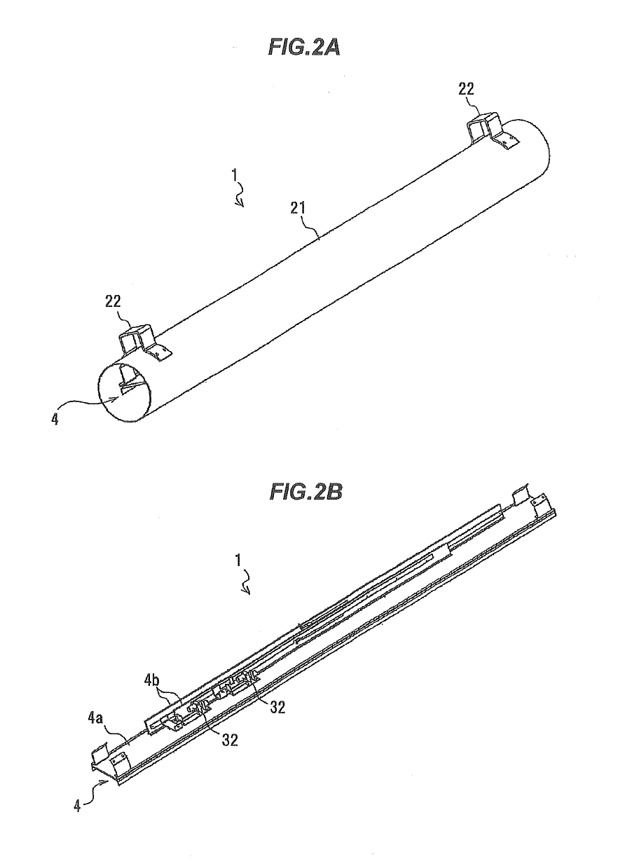

FIG. 2A is a perspective view showing an appearance of the antenna device in FIGS. 1A and 1B. FIG. 2B is a perspective view showing an internal configuration of a radome, in which the plurality of triplate lines and the antenna elements are partially not shown.

As shown in FIGS. 1A, 1B, 2A and 2B, an antenna device 1 is provided with one or more triplate line 4 as a feed line, each of which comprises a central conductor 2 and two ground plates 3 sandwiching the central conductor 2 via an air layer 9. The antenna device 1 is used as e.g. a mobile communication base station antenna.

The antenna device 1 comprises a radome 21 having a cylindrical shape. The radome 21 accommodates the triplate lines 4, and is closed by antenna caps (not shown) at both ends thereof. The radome 21 is provided with mounting brackets 22 for mounting the radome 21 on an antenna tower, etc. The antenna device 1 is mounted on the antenna tower, etc. with the mounting brackets 22 such that an axial direction (longitudinal direction) of the radome 21 is a vertical direction.

In the present embodiment, the antenna device 1, which is configured as a frequency sharing antenna for transmitting/receiving signals in two frequency bands, will be explained. When the antenna device 1 is used as the frequency sharing antenna for two frequency bands and both a vertical polarized wave and a horizontal polarized wave are used in each of the two frequency bands, four system feed lines would be required. If all the four system feed lines are incorporated in one triplate line 4, a space required for the triplate line 4 would be significantly increased and the size of an entire antenna device will be increased. Therefore, in the present embodiment, the triplate line 4 is divided into plural triplate lines and divided triplate lines are connected to be intersected with each other.

More specifically, the triplate line 4 comprises a first triplate line (lateral triplate line) 4a, and one or more second triplate line (vertical triplate line) 4b connected to be intersected with the first triplate line 4a. Here, one second triplate line 4b is provided for each of the four system feed lines. Namely, the total number of the second triplate lines 4b is four. These second triplate lines 4b (four in number) are connected to the first triplate line 4a such that the second triplate lines 4b are orthogonally intersected with the first triplate line 4a. In other words, the second triplate lines 4b are provided along a direction perpendicular to the first triplate line 4a and they are intersected with each other.

In the antenna device 1, a feed signal fed from outside the antenna device 1 is transmitted from the second triplate lines 4b to an antenna element portion 5 via the first triplate line 4a. In the present embodiment, the plurality of second triplate lines 4b (four in number) are arranged in parallel to be distant from each other. Two of the second triplate lines 4b for respective vertical and horizontal polarized waves in a low frequency band (e.g. 700 to 800 MHz) are located at both outer sides, while the other two of the second triplate lines 4b for respective vertical and horizontal polarized waves in a high frequency band (e.g. 1.5 to 2 GHz) are located at an inner side. The number of frequency bands to be shared is not limited to two. Further, the number and arrangement of the second triplate lines 4b are not limited to those shown in the attached drawings.

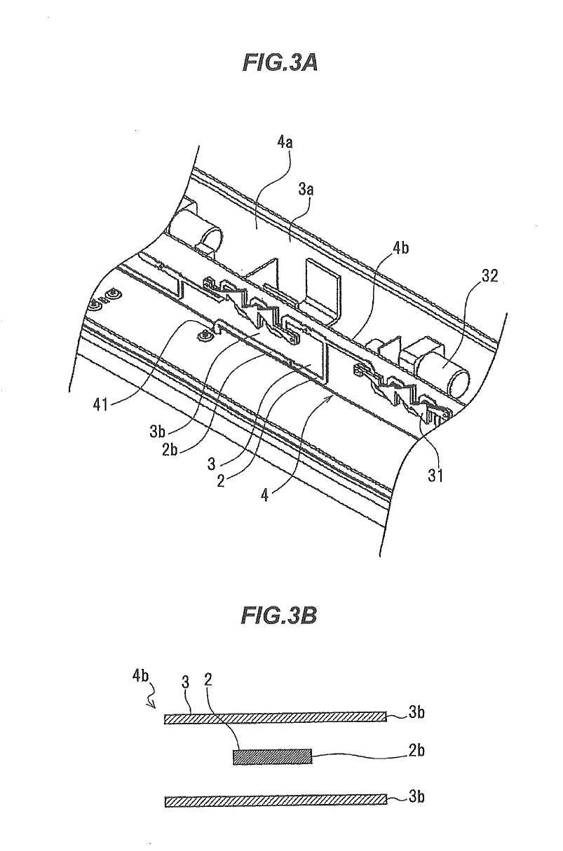

As shown in FIGS. 1A to 3B, each of the second triplate lines 4b comprises a central conductor plate 2b made of a metal plate as a central conductor 2, and two ground plates 3b for sandwiching the central conductor plate 2b via an air layer 9. The two ground plates 3b are opposite each other to be parallel with each other. The central conductor plate 2b is located in an equidistant position (i.e. equidistantly) from both of the two ground plates 3b, i.e., at a middle position between the two ground plates 3b. As the ground plate 3b, a plate made of aluminum which is light in weight, low in cost and excellent in weather resistance may be used.

In each of the second triplate lines 4b, the central conductor plate 2b is provided with a dielectric insertion type phase shifter 31 which is configured to distribute the feed signals input from the outside and adjust the phase of the feed signals for outputting the phase-adjusted signals to the first triplate line 4a. The dielectric insertion type phase shifter 31 is connected to a linear motor unit 32 for moving its dielectric plate along the central conductor plate 2b.

One end portion of the ground plate 3b of the second triplate line 4b is formed to have a flange shape. The flange portion is fixed to the ground plate 3a of the first triplate line 4a with bolts so that the second triplate line 4b is fixed to the first triplate line 4a as well as the ground plates 3a, 3b are electrically connected with each other.

The central conductor 2b of the second triplate line 4b includes a portion extended from the one end portion of the ground plate 3b, and the extended portion is inserted into a through-hole 41 formed at the ground plate 3a of the first triplate 4a, so that the central conductor plate 2b of the second triplate line 4b is electrically connected to a central conductor 2 (wiring pattern 2a) of the first triplate line 4a.

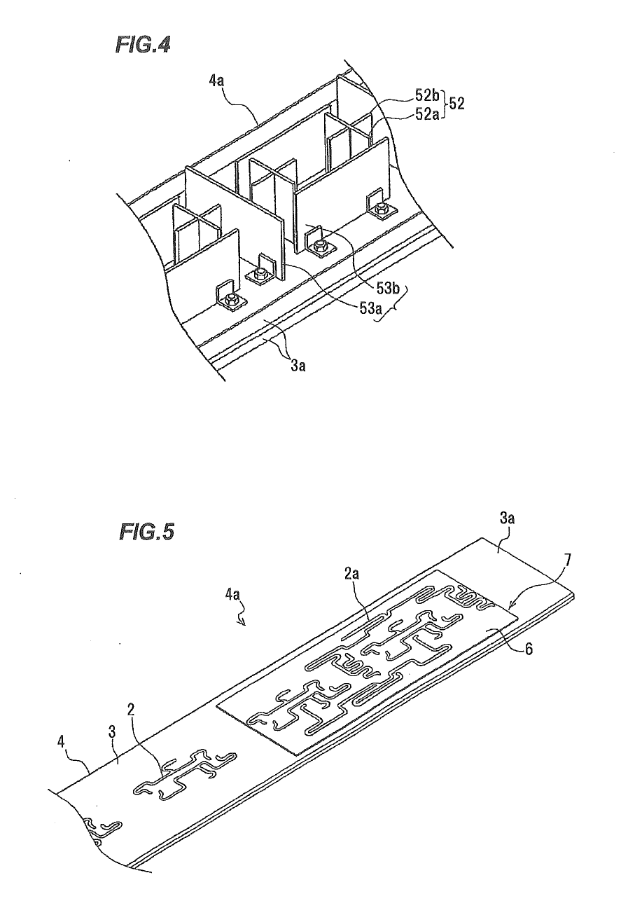

As shown in FIG. 4, an antenna element 51 is provided at the first triplate line 4a on the side opposite to the side provided with the second triplate lines 4b. Namely, in the antenna device 1, the second triplate lines 4b are provided at one ground plate 3a side of the first triplate line 4a and the antenna element 51 is provided at the other ground plate 3a side of the first triplate line 4a.

The antenna element 51 comprises a wiring pattern formed on a plate-like substrate comprising an electrically insulating material such as resin, and the antenna element 51 is installed in a standing manner on the one ground plate 3a of the first triplate line 4a.

The antenna element 51 has two antenna element pairs 52, 53 corresponding to the two frequency bands. A first antenna element pair 52 for a high frequency band has a first horizontal polarized antenna element 52a, and a first vertical polarized antenna element 52b. A second antenna element pair 53 for a low frequency band has a second horizontal polarized antenna element 53a, and a second vertical polarized antenna element 53b. It should be noted that the configuration and arrangement of the antenna element 51 are not limited to those shown in FIGS. 1A to 3B. The antenna element 51 is electrically connected with the central conductor 2 (wiring pattern 2a) of the first triplate line 4a through a through-hole 42 formed at the ground plate 3a of the first triplate line 4a (cf. FIG. 1A).

Referring to FIGS. 1B and 5, in the antenna device 1 according to the present embodiment, at least a part of the triplate lines 4 is configured such that the two ground plates 3 sandwich a center substrate 7 comprising the wiring pattern 2a as the central conductor 2 provided on a dielectric substrate 6 via an air layer 9, In the present embodiment, at least a part of the first triplate line 4a is configured such that the two ground plates 3a sandwich the center substrate 7 via the air layer 9. The dielectric substrate 6 may be e.g. FR4 (Flame Retardant Type 4) substrate. As the ground plate 3a, a plate made of aluminum which is light in weight, low in cost and excellent in weather resistance may be used.

Since the wiring pattern 2a provided on the center substrate 7 is used as the central conductor 2 of each of the triplate lines 4, even though the central conductor 2 is divided into a plurality of blocks, these parts or components can be handled as an integral part and the assembling thereof will be carried out easily.

In the antenna device 1 according to the present embodiment, the feed signals distributed by the second triplate lines 4b are further distributed to the respective antenna elements 51 through the first triplate line 4a. Therefore, the central conductor 2 of the first triplate line 4a is necessarily divided into plural (a lot of) blocks as shown in FIG. 5. Thus, the assembling of the antenna device 1 can be facilitated remarkably by providing the first triplate line 4a including the central conductor 2 to be divided into plural blocks with a triplate structure using the center substrate 7 (hereinafter referred to as “substrate triplate structure”).

It should be noted that, in the present embodiment, only the first triplate line 4a is explained as the substrate triplate structure, however, the present invention is not limited thereto. The second triplate line 4b may have the substrate triplate structure. It should be noted that when the substrate triplate structure is applied to the second triplate lines 4b, the assembling of the antenna device 1 will be facilitated but the dielectric loss may be increased, because the second triplate line 4b includes the central conductor 2 having a relatively long line length for distributing the feed signal.

Thus, it is preferable to apply the substrate triplate structure to only a portion in which a line length of the central conductor 2 is short and divided into plural portions, like the first triplate line 4a in the present embodiment, in order to suppress the dielectric loss at a low level.

As shown in FIG. 1B, the dielectric substrate 6 is located at the position where a distance “a” from one surface provided with the wiring pattern 2a as the central conductor 2 to the ground plate 3a facing to the one surface is greater than a distance “b” from the other surface opposed to the one surface to the ground plate 3a facing to the other surface.

It is necessary to locate the wiring pattern 2a as the central conductor 2 and the ground plate 3a to be close to each other to some extent, so as to secure isolation between the lines. At this time, the central conductor plate 2b of each of the second triplate lines 4b is soldered to the wiring pattern 2a. Therefore, when the wiring pattern 2a is too close to the ground plate 3b, a solder 8 for soldering the central conductor plate 2b may contact with the ground plate 3a. Thus, in the present embodiment, the dielectric substrate 6 is placed at a position closer to the other side opposite to the side formed with the wiring pattern 2a than a middle position between the two ground plates 3a, 3a, such that the isolation will be secured while the contact of the solder 8 to the ground plates 3a can be suppressed. Herein, the dielectric substrate 6 is located such that the two ground plates 3a are arranged equidistantly from the wiring pattern 2a.

Also, in the present embodiment, the center substrate 7 is configured such that the wiring pattern 2a is formed on an antenna element 51 side surface of the dielectric substrate 6. If the wiring pattern 2a is formed on a second triplate line 4b side surface, such a configuration may reduce a work space for soldering the wiring pattern 2a and the central conductor plate 2b after fixing the second triplate lines 4b, thereby the work of the soldering may become difficult.

The center substrate 7 is supported by the ground plate 3a via a spacer (not shown). The spacer is preferably provided at a region with no wiring pattern 2a of the center substrate 7. If the spacers are provided at a region with the wiring pattern 2a, the impedance will be varied so that it will be necessary to perform adjustment, e.g., to lengthen the line length. Namely, it is necessary to provide the spacer directly on the central conductor plate 2b in the triplate line 4 using the metal plate (central conductor plate 2b) for the central conductor 2, so that it will be necessary to perform adjustment, e.g., to lengthen the line length for impedance matching. Meanwhile, according to the substrate triplate structure, such an adjustment will become needless as well as the line length will be shortened and the center substrate 7 will be downsized. As a result, the installation work of the center substrate 7 will be carried out easily.

As described above, in the antenna device 1 according to the present embodiment, at least a part of the triplate line 4 is configured such that the two ground plates 3 sandwich the center substrate 7 comprising the wiring pattern 2a as the central conductor 2 provided on the dielectric substrate 6 via the air layer 9.

When a metal plate (central conductor plate) is used for the central conductor 2, the central conductor 2 is divided for respective frequencies and further for respective polarized waves in order to provide the frequency sharing, which would make the assembling work troublesome. According to the present embodiment, the center substrate 7 comprising the wiring pattern 2a as the central conductor 2 provided on the dielectric substrate 6 is used, so that the central conductors 2 for respective frequencies and for respective polarized waves can be integrated and the assembling work can be facilitated.

Also, according to the substrate triplate structure, it is not necessary to provide the spacer directly on the central conductor 2. Further, the wavelength shortening effect can be achieved by the presence of the dielectric substrate 6. In comparison with the case that the metal plate (central conductor plate) is used for the central conductor 2, the line length of the central conductor 2 can be shortened and the center substrate 7 will be downsized. As a result, the installation work of the center substrate 7 will be carried out more easily.

The present invention is not limited to the above embodiment, and modification or variation may be made without going beyond the scope of the present invention.

For example, the shape of the ground plate 3 or the central conductor 2 (including the center substrate 7) is not limited to a planar shape or plate-like shape and may be a curved shape.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. An antenna device, comprising:
a feed line comprising a triplate line, each triplate line comprising a central conductor and two ground plates sandwiching the central conductor via an air layer;
wherein at least a part of the triplate line is configured such that the two ground plates sandwich a center substrate comprising a wiring pattern as the central conductor provided on a dielectric substrate via the air layer.

2. The antenna device according to claim 1, wherein the dielectric substrate is located at a position where a first distance from one surface provided with the central conductor to one of the two ground plates facing to the one surface is greater than a second distance from the other surface opposed to the one surface to the other of the two ground plates facing to the other surface.

3. The antenna device according to claim 2, wherein dielectric substrate is located equidistantly from both of the two ground plates.

4. The antenna device according to claim 1, wherein the triplate line comprises a first triplate line and a second triplate line connected to be intersected with the first triplate line,
wherein a feed signal fed from outside is transmitted from the second triplate line to an antenna element via the first triplate line,
wherein at least a part of the first triplate lines is configured such that the two ground plates sandwich the center substrate via the air layer.

5. The antenna device according to claim 4, wherein the second triplate line is installed on a side of one of the two ground plates of the first triplate line and the antenna element is installed on a side of the other of the two ground plates of the first triplate line,
wherein the center substrate comprises the central conductor on the dielectric substrate on a side of the antenna element.

6. The antenna device according to claim 1, wherein the center substrate is supported by the two ground plates via a spacer provided at a region of the center substrate, and the region is not provided with the spacer.
